(19) United States
(12) Patent Application Publication
(10) Pub. No.: US 2003/0233469 A1
(43) Pub. Date: Dec. 18, 2003

(54) Content server

(76) Inventors: Kenneth L. Knowlson, Beaverton, OR (US); Dzung Tran, Beaverton, OR (US); Marci L. Lehman, Beaverton, OR (US); Brian E. Woodruff, Tigard, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/170,943

(22) Filed: Jun. 12, 2002

(51) Int. Cl. G06F 15/173

(52) U.S. Cl. 709/238

(57) ABSTRACT

The claimed subject matter relates to dynamically routing content to a dedicated entertainment device and, more particularly, to the dynamic routing of content from a content server to one or more dedicated entertainment devices.

### BACKGROUND

1. Field

The claimed subject matter relates to dynamically routing content to a dedicated entertainment device and, more particularly, to the dynamic routing of content from a content server to one or more dedicated entertainment devices.

2. Background Information

Currently, a number of discrete, autonomous devices exist to process content.

Typically, in order to process content on multiple devices, a number of these discrete, autonomous devices must be specifically coupled and configured to access the same content. For example, in order to watch a Digital Versatile Disc (DVD) movie on a television and listen to the audio portion of the movie on a stereo, a user must statically route the appropriate ports of the DVD player to the desired devices.

In addition, typically, in order to play a DVD movie at a second location, at a minimum, the disc is physically moved to the second location, and that location must be equipped with a second television and a second DVD player. If the second location is only equipped with a television and does not have access to a second DVD player, the first DVD player must be un-coupled from the first television and stereo, physically moved and coupled to the second television. A similar and equally cumbersome process must be performed if the second location does not contain a television.

Often this cumbersome task deters the ability to enjoy the content of the DVD or other content. A need, therefore, exists for an improved system or technique for routing and distributing content to a content processing device.

### BRIEF DESCRIPTION OF THE DRAWINGS

Subject matter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a block diagram illustrating an embodiment of a content server and a plurality of dedicated entertainment devices in accordance with an embodiment of the claimed subject matter;

FIG. 2 is a flowchart diagram illustrating an embodiment of a technique to route content to a variety of dedicated entertainment devices in accordance with an embodiment of the claimed subject matter.

FIG. 3 is a block diagram illustrating an embodiment of a content server in accordance with an embodiment of the claimed subject matter.

### DETAILED DESCRIPTION

In the following detailed description, numerous details are set forth in order to provide a thorough understanding of the present claimed subject matter. However, it will be understood by those skilled in the art that the claimed subject matter may be practiced without these specific details. In other instances, well-known methods, procedures, components, and circuits have not been described in detail so as to not obscure the claimed subject matter.

As used herein, “content” is substantially the subject matter or meaningful part of a copyrightable work which is intended to be perceived by the senses, such as, for example, the written work of a magazine or book, a movie, a song, a picture, etc. However, these are merely a few non-limiting examples a copyrightable work which is intended to be perceived by the senses; one skilled in the art will realize that there are other examples. As used herein, content may includes incidental information, such as, for example, header information utilized by the format the content is stored in, or digital rights management information.

As used herein, the term “storage format” refers to the particular data format content is stored, such as, for example, Audio Video Interleaved (AVI) format, Motion Picture Expert Group—Layer 3 (MP3) format, Tagged Image File Format (TIFF). However, these are merely a few non-limiting examples; one skilled in the art will realize that there are many possible storage formats. One skilled in the art will realize that the term “storage format” may also include the media which is utilized to store the content, such as, for example, compact disc (CD), magnetic disc, magnetic tape, optical media.

As used herein, the term “sensory format” refers to the particular sense or senses which a particular form of content is meant to be perceived. For example, music is generally intended to be perceived by hearing; although, one skilled in the art will understand that video may be substantially synchronized with music. This video would be perceived via sight. Some content, such as, for example, a movie may be intended to be perceived by multiple senses, such as, sight and hearing. Additional formats are contemplated.

As used herein, a “dedicated entertainment device” is a device whose primary function is to render, display, or perform content, often for entertainment. Although a dedicated entertainment device is not typically used for the production of content, a dedicated entertainment device may receive, as input, content in a first format and produce, as output, content in a second format. For example, a radio may receive music as a frequency modulated (FM) signal and output music in an audible format. In another example, a CD player may receive music in a digital format and may output the music via a signal that may be further processed by an amplifier. These are merely a few specific examples and that many other examples of dedicated entertainment devices may be used.

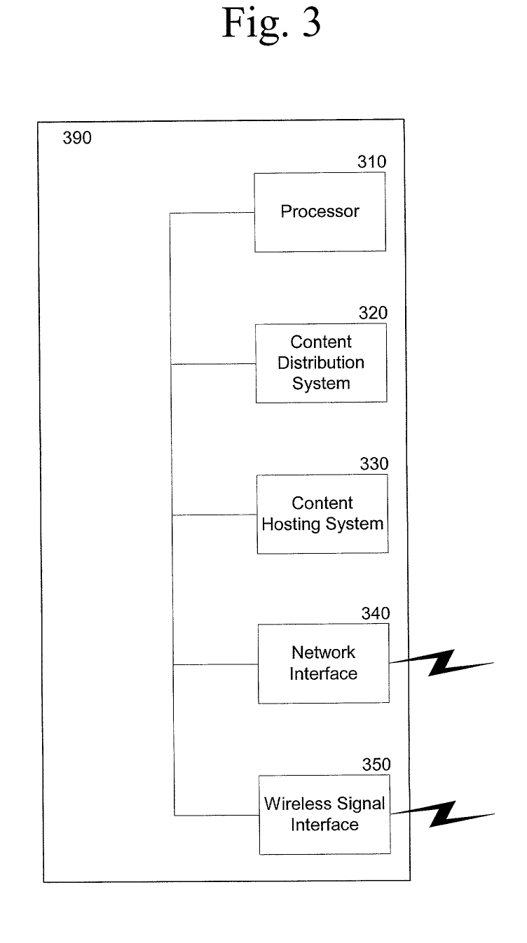

As used herein, an “entertainment content server” is a device that is capable of storing or accessing a variety of content in a variety of formats. This device is further able to route or push the content to a variety of dedicated entertainment devices. As illustrated by FIG. 3, an entertainment content server 390 will generally include a processor 310, a content distribution system 320, and a network interface 340. In some embodiments an entertainment content system may include a content hosting system 320 or a wireless signal interface 350. It is contemplated that, in some embodiments, an entertainment content server may also act as a dedicated entertainment device. It is further contemplated that a content server may be a single purpose device or a multipurpose device, of which routing or pushing content is merely one function.

As used herein, an “entertainment control device” is a device that is capable of requesting content and possibly directing where, when and/or how the content is displayed. An entertainment control device may be a device, such as, for example, an infrared wireless remote control, a wall-mounted control panel, a personal digital device, or a general-purpose computer. However, these are merely a few non-limiting examples to which the claimed subject matter is not limited. It is contemplated that an entertainment control device may be integrated within a dedicated entertainment device or entertainment content server.

As used herein, a “content hosting device” is a device that is capable of storing content. In some embodiments of a content hosting device, the hosting device my transmit content to a dedicated entertainment device. It other embodiments, the content hosting device may be a proxy server that caches content from a high latency source. However, these are merely two non-limiting illustrative examples of a content hosting device. It is contemplated that a content hosting device may be integrated within a dedicated entertainment device or entertainment content server.

As used herein, a “push” is a form of communication in which a server directly initiates communication with a client. This is contrasted with a “pull” form of communication, in which a client directly initiates communication with a server. An example of pulling content may be browsing a web page. An example of a pushing content may be a system that sends weather information from a server to a client, without the client directly requesting each content transfer.

It is contemplated that a push communication may include instances where the client indirectly initiates communication with the server. For example, a client may request that weather information be sent to the client every hour. Each hour the server may initiate communication with the client, and transmit weather information to the client. In this example, the client is considered to have indirectly initiated the hourly transmission of content, but each hourly transmission would be directly pushed from the server. In other example of push communication a server may push the network address or universal resource locator (URL) of a third device to a client. The client may then pull content from the third device using the given network address or URL. It is also contemplated that the push form of communication may be directed by a third device. For example, a third device may instruct a server to push content to a client device.

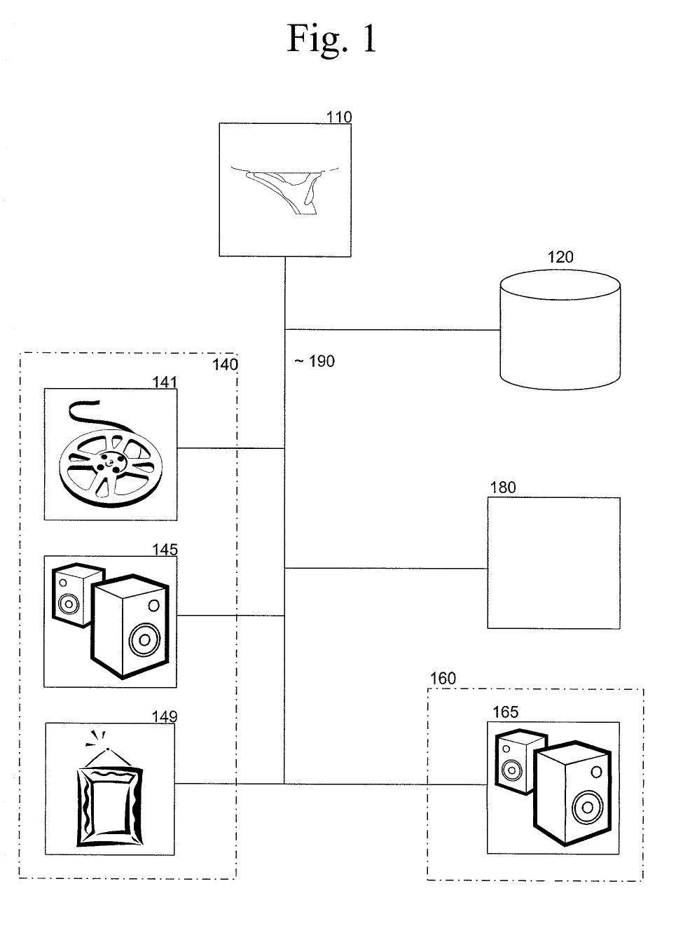

FIG. 1 is a block diagram illustrating a system in accordance with the claimed subject matter. Entertainment content server 110 and dedicated entertainment devices 141, 145, 149, and 160 may be in communication with each other via network 190. In this particular embodiment, all content is transmitted via network 190 in a digital format. One skilled in the art will realize that the network may utilize many types of protocols, such as, for example, a wired protocol, a wireless protocol, or a mix of both. Entertainment content server 110 may have access to a content hosting device 120. It is contemplated that content hosting device 120 may be part of content server 110 or, alternatively, an independent device.

In a specific example, entertainment content server 110 may be a multi-purpose device, such as, for example, a computer which accesses content from the storage media of the computer. Conversely, entertainment content server 110 may be a single purpose device, such as, for example, a device akin to a component device for a stereo or home theater system. It is contemplated that an entertainment content server may take a variety of forms and be packaged and productized in a variety of ways and that these are merely two non-limiting examples.

The various dedicated entertainment devices illustrated in FIG. 1 may process a variety of content formats, both sensory and storage formats. To continue the above specific example, dedicated entertainment device 141 may be, for example, a television capable of processing both audio and video content. Dedicated entertainment device 145 may be, for example, a stereo system capable of processing audio content. Dedicated entertainment device 149 may be, for example, a digital picture frame capable of processing digital still pictures. Dedicated entertainment device 165 may also be, for example, a stereo system capable of processing audio content. It is contemplated that a large variety of dedicated entertainment devices may be used and that this is merely one specific, non-limiting example. The claimed subject matter is not limited to the sensory formats detailed in this specific example.

Dedicated entertainment devices 141, 145, and 149 may be substantially located in a first location 140. Whereas, other dedicated entertainment devices, such as, dedicated entertainment device 165, may be located in a second location 160. It is contemplated that a number of locales may be used. In the specific example above, the system may be located within a house. Therefore, the first location 140 may be, for example, a living room. The second location 160 may be, for example, a bedroom. While the entertainment content server 110 need not necessarily reside in a particular locale, in this specific example it may reside in a utility closet. These locales are merely examples, and that the claimed subject matter is not limited to any specific locale. Likewise, while the specific example involves a house, it is understand that the claimed subject matter in not limited to a residential setting.

In the embodiment illustrated by FIG. 1, entertainment content server 110 may receive a request for content from entertainment control device 180. In a specific example, entertainment control device 180 may be a device, such as, for example, a remote control or a component of a dedicated entertainment device; however, these are merely a few non-limiting examples. Entertainment content server 110 may instruct content hosting device 120 to push content to an appropriate dedicated entertainment device. In the specific example above, the content server 110 may receive a request to push music to the stereo in the living room, dedicated entertainment device 145.

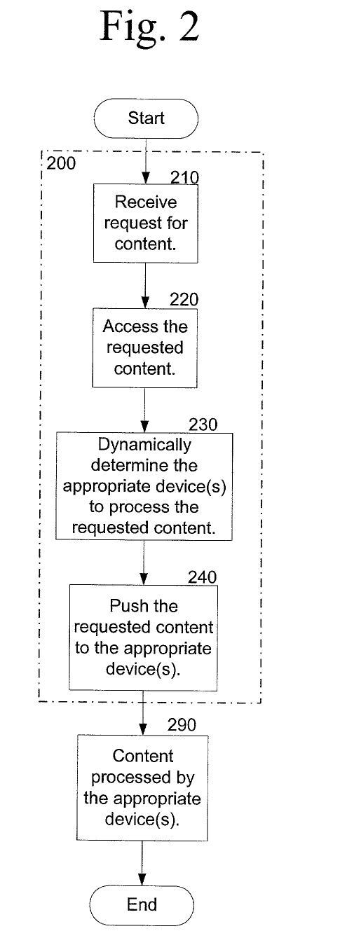

The entertainment content server 110 may perform these actions in accordance with the actions 200 as illustrated by FIG. 2. As illustrated by action 210, an entertainment content server may receive a request for content. It is contemplated that the entertainment content server may receive a request through a variety of ways, such as, for example, a request via a wired or wireless network, or, alternatively a signal from an entertainment control device. Such a signal may, for example, be a signal in the radio or, in another example, the infrared frequency spectrum. These are merely a few nonlimiting techniques for requesting content.

Action 220 illustrates that, upon receiving the request, the entertainment content server may access the requested content. Upon accessing the content a variety of properties may be determined, such as, for example, the storage format of the content, the sensory format of the content, the latency associated with accessing the content, or any digital rights management scheme associated with the content. It is contemplated that other properties may be examined and that particular properties may be more or less important depending upon the situation and implementation of the embodiment.

Upon accessing the content and assessing its properties, the content server may determine the appropriate dedicated entertainment device to process the requested content. This is illustrated by action 230. In order to determine the appropriate dedicated entertainment device to receive the requested content, the entertainment content server may utilize a collection of data that stores a set of properties associated with the various dedicated entertainment devices. Such a collection of data may include data, such as, for example, the physical location of the device, the capability of the device to process the requested content, a substantially user configurable setting or preference, or the ability of the content server to route content to the device. These are merely a few non-limiting examples of data, which may be utilized by the content server in order to select an appropriate device. It is contemplated that such a collection of data may be preconfigured into the server, dynamically amassed or a variant thereof.

In one embodiment of the claimed subject matter, the entertainment content server may determine the physical location of a dedicated entertainment device by dynamically inferring the device's location. Alternatively, some embodiments may determine the location of a device by statically configuring the location of the dedicated entertainment device, or receiving a signal from the dedicated entertainment device or the entertainment control device. One embodiment of the claimed subject matter may dynamically infer the location of a dedicated entertainment device by utilizing the network address of the device. In a specific example, every dedicated entertainment device located within living room 140 may be assigned an address within a certain range of addresses. If an entertainment content server detects that a device is assigned a network address within that range, the content server may assume that the device is located within living room 140. Other embodiments may utilize different techniques for inferring the location of the dedicated entertainment device, such as, for example, a network name of the device, a location of at least one device which is physically coupled with the dedicated entertainment device, a triangulation involving wireless signals used to communicate with the device, and an operating mode of the entertainment control device at the time the request for content was received. These are merely a few non-limiting examples of techniques that may be used to dynamically infer the location of a dedicated entertainment device.

Dynamically amassing the collection of data may be aided by using a network protocol that allows a dedicated entertainment device to provide information about itself, upon being connected to a network. Such a protocol may allow actions, such as, for example, dynamically configuring the device, acquiring a network address, and using a discovery protocol to announce the presence of the device on the network. Such a protocol may be substantially in compliance with the Universal Plug and Play (UPnP) standard. Universal Plug and Play Device Architecture, Ver. 1.0, June 2000, Microsoft Corp. It is contemplated that other techniques and protocols may be used to facilitate dynamically amassing the collection of data.

While specific examples of determining an appropriate dedicated entertainment device to process the requested content are discussed below, a general example may involve a request to play audio content that is stored in the MP3 format. The entertainment content server may be in communication with a number of devices. Upon consulting the collection of data stored in the server, the server may determine that there are three dedicated entertainment devices capable of processing audio content, but that only one device is capable of processing audio content stored in the MP3 format. Accordingly, the server may designate that dedicated entertainment device as the appropriate dedicated entertainment device to process the requested content. This is merely one non-limiting example of the claimed subject matter. It is contemplated that it is possible for the content server to reformat the storage format, or other properties, of the content in order to make the content more accessible to a device. It is further contemplated that more than one device may be appropriate to process the requested content.

Action 240 illustrates that the requested content may be pushed to the appropriate dedicated entertainment device. For example, if the requested content is stored on the entertainment content server, the content may be transmitted from the entertainment content server to the dedicated entertainment device. In another example, if the requested content is stored on a separate device, a content hosting device, the entertainment content server may request that the content hosting device push the requested content to the dedicated entertainment device. In yet a third example, the content may stored on a content hosting device. In this example, the entertainment content server may push a network identifier or universal resource identifier (URI) to the dedicated entertainment device. This identifier may inform the dedicated entertainment device that the content is on the content hosting device and any information used to retrieve the content. The dedicated entertainment device may, using the identifier pull the content from the content hosting device. However, these are merely a few non-limiting illustrative examples of embodiments that would conform to action 240. It is contemplated that the requested content may be stored in multiple locations and that the entertainment content server may determine which location to push the content from.

In one embodiment, content may be pushed from a content hosting device to a dedicated entertainment device by having the content hosting device initiate communication with the dedicated entertainment device. After communication is established, the content hosting system may route content from the hosting device to the dedicated entertainment device. It is contemplated that the content may be routed to the dedicated entertainment device from a third device.

Likewise, it is contemplated that the requested content may include separate parts stored in a common or multiple locations. The separate parts of the requested content may be pushed to one or more dedicated entertainment devices. In one embodiment, the requested content may be partitioned into two or more parts. Each part may be transmitted to individual dedicated entertainment devices. Several criteria may be used to partition the requested content, such as, for example, a digital rights scheme associated with the content, the sensory or storage format of the content, a preconfigured setting, a temporal marker, the location of the dedicated entertainment device to which the content is pushed, or the latency associated with the content. However, these are merely a few non-limiting examples. It is contemplated that the transmission of the content may involve streaming the content or fully transmitting the content before processing, or a variant thereof.

Action 290 illustrates that upon sufficiently receiving the requested content, the content is processed by the dedicated entertainment device, wherein sufficiently receiving is determined via factors, such as, for example, quality and quantity. As detailed above, processing may include receiving content in an normally non-perceivable format and converting it to a perceivable format. Alternatively, processing may include receiving content in a first normally non-perceivable format and converting it to a second normally non-perceivable format. For example, a radio may receive music as a frequency modulated (FM) signal and output music in an audible format. In another example, a CD player may receive music in a digital format and may output the music via a signal that may be further processed by an amplifier. Of course, these are merely two examples of processing content. It is contemplated that the entertainment content server may process the requested content, if the server determines that the server is the appropriate dedicated entertainment device to process the requested content.

Returning to the specific example associated with FIG. 1, a user may wish to view a slideshow in the living room 140, where television 141, stereo 145, and picture frame 149 are located. A user may request, via a remote control 180, that entertainment content server 110 route a slideshow, stored on content hosting device 120, to the living room 140.

Entertainment content server 110 may perform the actions illustrated by FIG. 2. As shown by action 220, the content server may access the content comprising the slideshow and determine that the content includes a series of still pictures. As shown by action 230, the content server may determine that the digital picture frame, illustrated by device 149 in FIG. 1, is the appropriate dedicated entertainment device to process the content. This may be determined by the ability of the digital picture frame to process still pictures, and user's request to view the slideshow in the living room. The content server may push the content via the network to the digital picture frame. Upon receiving the content, the digital picture frame may display the series of still pictures.

In another specific example associated with FIG. 1, a user may wish to view a movie in the living room 140, where television 141, stereo 145, and picture frame 149 are located. A user may request, via a remote control 180, that content server 110 route a movie, stored by content hosting device 120, to the living room 140.

Entertainment content server 110 may perform the actions illustrated by FIG. 2. As shown by action 220, the content server may access the content comprising the movie and determine that the content includes both a video and audio component. As shown by action 230, the content server may determine that the television, illustrated by device 141 in FIG. 1, is the appropriate dedicated entertainment device to process the video component of the content. This may be determined by the ability of the television to process video signals, and user's request to view the movie in the living room. The content server may also determine that the stereo, illustrated by device 145, is the appropriate dedicated entertainment device to process the audio component of the content. This may be determined by the ability of both the television and stereo to process the content, the user's request to view the movie in the living room, and possibly a preconfigured setting that specifies that the stereo is the preferred device to process audio content.

In a third specific example associated with FIG. 1, a user may wish to listen to music in the living room 140 until a certain time, for example, 6:00 pm, and then continue to listen to music in the bedroom 160, which includes stereo 165. A user may request that entertainment content server 110 push the music, stored by content hosting device 120, as described above.

Entertainment content server 110 may perform the actions illustrated by FIG. 2. As shown by action 220, the content server may access the content comprising the music and determine that the content includes an audio component. As shown by action 230, the content server may determine that the living room stereo, illustrated by device 145, is the appropriate device to process the audio component of the content. This may be determined by the ability of both the television and stereo to process the content, the user's request to listen to the music in the living room, and possibly a preconfigured setting that specifies that the stereo is the preferred device to process audio content. At the predetermined time, in this example 6:00 pm, the content server may determine that the bedroom stereo, illustrated by 165, is the appropriate dedicated entertainment device and re-route the audio content to the bedroom stereo.

The above examples illustrate that the entertainment content server 110 may be capable of pushing a first part of the requested content to a first dedicated entertainment device and a second part of the content to a second dedicated entertainment device. A variety of criteria may be utilized to distinguish between two or more parts of the requested content, such as, for example, a temporal division, a division based upon physical location, and the sensory or storage format of the content. These are merely a few non-limiting examples and that other criteria may be used. It is contemplated that the content may be sub-divided into more than two parts.

It is contemplated that the signal transmitted by the entertainment control device, such as, for example, the remote control illustrated by the above examples, may be detected by the content server or detected by another device and the request forwarded to the content server. It is further contemplated that the above specific examples are merely illustrative examples and are not limiting on the claimed subject matter.

The techniques described herein are not limited to any particular hardware or software configuration; they may find applicability in any computing or processing environment. The techniques may be implemented in hardware, software or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact read only memory (CD-ROM), digital versatile disk (DVD), hard disk, magnetic disk or similar medium or device, that is readable by a general or special purpose programmable machine for configuring and operating the machine when the storage medium or device is read by the computer to perform the procedures described herein. The system may also be considered to be implemented as a machine-readable storage medium, configured with a program, where the storage medium so configured causes a machine to operate in a specific manner. Other embodiments are within the scope of the following claims.

While certain features of the claimed subject matter have been illustrated and described herein, many modifications, substitutions, changes, and equivalents will now occur to those skilled in the art. It is, therefore, to be understood that the appended claims are intended to cover all such modifications and changes that fall within the true spirit of the claimed subject matter.

What is claimed is:

1: A method of using an entertainment content server comprising:
receiving a request for content, from an entertainment control device;
accessing the requested content;
dynamically determining at least one dedicated entertainment device to receive at least part of the requested content; and
pushing at least a first part of the content to the at least one dedicated entertainment device.

2: The method of claim 1, wherein determining at least one dedicated entertainment device includes selecting the at least one dedicated entertainment device based at least in part upon one of the following:
a physical location of the dedicated entertainment device,
a capability of the device to process a selected content format,
a substantially predetermined setting, and
an ability to transmit the requested content to the dedicated entertainment device.

3: The method of claim 2, wherein the physical location of the dedicated entertainment device is determined utilizing one of the following:
statically configuring the content server with the location of the dedicated entertainment device,
receiving a signal representing the location of the dedicated entertainment device from the dedicated entertainment device,
receiving a signal representing the location of the dedicated entertainment device from the entertainment control device, and
dynamically inferring the location of the dedicated entertainment device.

4: The method of claim 3, wherein dynamically inferring the location of the dedicated entertainment device includes utilizing, at least in part, one of the following:
a network address of the dedicated entertainment device,
a network name of the dedicated entertainment device,
a location of at least one device physically coupled with the dedicated entertainment device,
a triangulation involving a wireless signal used to communicate with the dedicated entertainment device, and
an operating mode of the entertainment control device at the time the received request for content was transmitted.

5: The method of claim 2, wherein determining the capability of the dedicated entertainment device to process a selected content format comprises utilizing a network protocol which allows the dedicated entertainment device to:
dynamically configure a group of settings relating to the dedicated entertainment device,
acquire a network address, and
use a discovery protocol to announce the presence of the dedicated entertainment device on the network.

6: The method of claim 1, wherein accessing the requested content includes determining at least one of the properties of the requested content selected from the following:
a storage format of the content,
a digital rights management scheme associated with the content,
a sensory format of the content, and
a latency associated with accessing the content.

7: The method of claim 1, wherein pushing at least a first part of the content to the at least one dedicated entertainment device comprises transmitting at least part of the content over a network in digital form.

8: The method of claim 7, wherein pushing at least a first part of the content to the, at least one, dedicated entertainment device includes:
the entertainment content server initiating communication between the entertainment content server and the at least one dedicated entertainment device;
the entertainment content server transmitting a network identifier to the at least one dedicated entertainment device;
the at least one dedicated entertainment device initiating communication between a content hosting device and the at least one dedicated entertainment device;
utilizing the network identifier, routing at least a first part of the content from the content hosting device to the at least one dedicated entertainment device.

9: The method of claim 7, wherein pushing at least a first part of the content to the, at least one, dedicated entertainment device includes:
a content hosting device initiating communication between the content hosting device and the at least one dedicated entertainment device;
routing at least a first part of the content from the content hosting device to the at least one dedicated entertainment device.

10: The method of claim 9, wherein the entertainment content server includes the content hosting device.

11: The method of claim 7, wherein pushing at least a first part of the content to the at least one dedicated entertainment device includes:
partitioning the content into a first part and at least a second part,
pushing a first part of the content to a first dedicated entertainment device, and
pushing a second part of the content to a second dedicated entertainment device.

12: The method of claim 11, wherein partitioning the content into a first and second part comprises partitioning the content based upon at least one of the following:
a digital rights management scheme associated with a part of the content,
a latency associated with accessing a part of the content.
a physical location of the dedicated entertainment device to which a part of the content is pushed,
a sensory format of a part of the content,
a storage format of a part of the content,
a substantially predetermined setting, and
a temporal marker.

13: The method of claim 12, further comprising the at least one dedicated entertainment device processing the content.

14: An apparatus comprising:
a processor;
a network interface; and
a content distribution system;
wherein the processor, the network interface, and the content distribution system are coupled so as to, during operation,
receive a request for content,
dynamically determine at least one dedicated entertainment device to receive the content, and
push at least part of the content to the at least one dedicated entertainment device.

15: The apparatus of claim 14, wherein the content distribution system, during operation, dynamically determines at least one dedicated entertainment device to receive the content based at least in part upon one of the following:
a physical location of the dedicated entertainment device,
a capability of the dedicated entertainment device to process the selected content format,
a capability of the apparatus to route the requested content to the dedicated entertainment device, and
a substantially user configurable setting.

16: The apparatus of claim 15, wherein the content distribution system, during operation, determines the physical location of the dedicated entertainment device utilizing one of the following:
a statically configured setting,
a signal representing the location of the dedicated entertainment device, that is transmitted by the dedicated entertainment device,
a signal representing the location of the dedicated entertainment device, that is transmitted by an entertainment control device, and
a dynamically inferred location of the dedicated entertainment device.

17: The apparatus of claim 16, wherein the content distribution system, during operation, infers the location of the dedicated entertainment device utilizing, at least in part, one of the following:
a network address of the dedicated entertainment device,
a network name of the dedicated entertainment device,
a location of at least one device physically coupled with the dedicated entertainment device,
a triangulation involving a wireless signal used to communicate with the dedicated entertainment device, and
an operating mode of the entertainment control device at the time the received request for content was transmitted.

18: The apparatus of claim 15, wherein the content distribution system, during operation, determines the capability of the dedicated entertainment device to process a selected content format utilizing a network protocol which allows the dedicated entertainment device to:
dynamically configure a group of settings related to the dedicated entertainment device,
acquire a network address, and
use a discovery protocol to announce the presence of the dedicated entertainment device on a network.

19: The apparatus of claim 15, further comprising a wireless signal interface;
wherein the processor, the network interface, and the content distribution system are coupled so as to, during operation, receive a request for content, via the wireless signal interface, and
wherein the wireless signal interface is configured to accept wireless signals from at least one of the following:
the radio frequency spectrum, and
the infrared frequency spectrum.

20: The apparatus of claim 14, wherein, to facilitate pushing at least part of the content to the at least one dedicated entertainment device, the processor, the network interface, and the content distribution system are coupled so as to, during operation, facilitate
an initiation of communication from the apparatus to the at least one dedicated entertainment device;
a transmission of a network identifier to the at least one dedicated entertainment device;
wherein the network identifier facilitates the at least one dedicated entertainment device to initiate communication between a content hosting device and the at least one dedicated entertainment device; and
the network identifier further facilitates routing at least a first part of the content from the content hosting device to the at least one dedicated entertainment device.

21: The apparatus of claim 14, wherein, to facilitate pushing at least part of the content to the at least one dedicated entertainment device, the processor, the network interface, and the content distribution system are coupled so as to, during operation, facilitate
an initiation of communication from a content hosting device to the at least one dedicated entertainment device, and
a routing of at least a first part of the content from the content hosting device to the at least one dedicated entertainment device.

22: The apparatus of claim 21, further comprising a content hosting system;
wherein the processor, the network interface, and content hosting system are coupled so as to be a content hosting device that stores content.

23: The apparatus of claim 15, wherein the content distribution system, during operation,
partitions the content into a first part and at least a second part,
pushes the first part of the content to a first dedicated entertainment device, and
pushes at least the second part to at least a second entertainment device.

24: The apparatus of claim 23, wherein the content distribution system, during operation, partitions the content into a first part and at least a second part based upon at least one of the following:
a digital rights management scheme associated with a part of the content,
a latency associated with accessing a part of the content.
a physical location of the dedicated entertainment device to which a part of the content is pushed,
a sensory format of a part of the content,
a storage format of a part of the content,
a substantially predetermined setting, and
a temporal marker.

25: A system comprising:
a content server, including
a processor,
a network interface, and
a content distribution system; and
a plurality of dedicated entertainment devices;
wherein the content server and the plurality of dedicated entertainment devices are coupled so as to, during operation, allow at least one of the plurality of dedicated entertainment devices to receive and process content, which is dynamically pushed to at least one the plurality of dedicated entertainment devices by the content server.

26: The system of claim 25, wherein the plurality of dedicated entertainment devices includes:
at least one dedicated entertainment device that, during operation, reformats and transmits content such that other devices may play the content, and
at least one dedicated entertainment device, during operation, plays content.

27: The system of claim 26, wherein at least one of the plurality of dedicated entertainment devices utilizes, during operation, a network protocol which allows the dedicated entertainment device to:
dynamically configure a group of settings related to the dedicated entertainment device,
acquire a network address, and
use a discovery protocol to announce the presence of the dedicated entertainment device on a network.

28: The system of claim 25, wherein the content server, during operation,
receives a request for content,
dynamically determines at least one dedicated entertainment device to receive the content, and
pushes at least part of the content to the at least one dedicated entertainment device.

29: The system of claim 28, wherein the content distribution system, during operation, dynamically determines at least one dedicated entertainment device to receive the content based at least in part upon one of the following:
a physical location of the dedicated entertainment device,
a capability of the dedicated entertainment device to process the selected content format,
a capability of the apparatus to route the requested content to the dedicated entertainment device, and
a substantially user configurable setting.

30: The system of claim 29, wherein the content distribution system, during operation, determines the physical location of the dedicated entertainment device utilizing one of the following:
a statically configured setting,
a signal representing the location of the dedicated entertainment device, that is transmitted by the dedicated entertainment device,
a signal representing the location of the dedicated entertainment device, that is transmitted by an entertainment control device, and
a dynamically inferred location of the dedicated entertainment device.

31: The system of claim 30, wherein the content distribution system, during operation, infers the location of the dedicated entertainment device utilizing, at least in part, one of the following:
a network address of the dedicated entertainment device,
a network name of the dedicated entertainment device,
a location of at least one device physically coupled with the dedicated entertainment device,
a triangulation involving a wireless signal used to communicate with the dedicated entertainment device, and
an operating mode of the entertainment control device at the time the received request for content was transmitted.

32: The system of claim 28, wherein, to facilitate pushing at least part of the content to the at least one dedicated entertainment device, the processor, the network interface, and the content distribution system are coupled so as to, during operation, facilitate
an initiation of communication from the content server to the at least one dedicated entertainment device;
a transmission of a network identifier to the at least one dedicated entertainment device;
wherein the network identifier facilitates the at least one dedicated entertainment device to initiate communication between a content hosting device and the at least one dedicated entertainment device; and
the network identifier further facilitates routing at least a first part of the content from the content hosting device to the at least one dedicated entertainment device.

33: The system of claim 28, wherein, to facilitate pushing at least part of the content to the at least one dedicated entertainment device, the processor, the network interface, and the content distribution system are coupled so as to, during operation, facilitate
an initiation of communication from a content hosting device to the at least one dedicated entertainment device, and
a routing of at least a first part of the content from the content hosting device to the, at least one, dedicated entertainment device.

34: The system of claim 33, further comprising a content hosting system;
wherein the processor, the network interface, and content hosting system are coupled so as to be a content hosting device that stores content.

35: The system of claim 34, wherein the content distribution system, during operation,
partitions the content into a first part and at least a second part,
pushes the first part of the content to a first dedicated entertainment device, and
pushes at least the second part to at least a second entertainment device.

36: The system of claim 35, wherein the content distribution system, during operation, partitions the content into a first part and at least a second part based upon at least one of the following:
a digital rights management scheme associated with a part of the content,
a latency associated with accessing a part of the content.
a physical location of the dedicated entertainment device to which a part of the content is pushed,
a sensory format of a part of the content,
a storage format of a part of the content,
a substantially predetermined setting, and
a temporal marker.

37: An article comprising:
a storage medium having a plurality of machine accessible instructions, wherein when the instructions are executed by a processor, the instructions provide for
receiving a request for content, from an entertainment control device;
accessing the requested content;
dynamically determining at least one dedicated entertainment device to receive at least part of the requested content; and
pushing at least a first part of the content to the at least one dedicated entertainment device.

38: The article of claim 37, wherein the instructions that provide for determining at least one dedicated entertainment device includes instructions for selecting the at least one dedicated entertainment device based at least in part upon one of the following:
a physical location of the dedicated entertainment device,
a capability of the device to process a selected content format,
a substantially predetermined setting, and
an ability to transmit the requested content to the dedicated entertainment device.

39: The article of claim 38, wherein the instructions provide that the physical location of the dedicated entertainment device is determined utilizing one of the following:
statically configuring the content server with the location of the dedicated entertainment device,
receiving a signal representing the location of the dedicated entertainment device from the dedicated entertainment device,
receiving a signal representing the location of the dedicated entertainment device from the entertainment control device, and
dynamically inferring the location of the dedicated entertainment device.

40: The article of claim 39, wherein the instructions provide that dynamically inferring the location of the dedicated entertainment device includes utilizing, at least in part, one of the following:
a network address of the dedicated entertainment device,
a network name of the dedicated entertainment device,
a location of at least one device physically coupled with the dedicated entertainment device,
a triangulation involving a wireless signal used to communicate with the dedicated entertainment device, and
an operating mode of the entertainment control device at the time the received request for content was transmitted.

41: The article of claim 38, wherein the instructions provide that determining the capability of the dedicated entertainment device to process a selected content format comprises utilizing a network protocol which allows the dedicated entertainment device to:
dynamically configure a group of settings relating to the dedicated entertainment device,
acquire a network address, and
use a discovery protocol to announce the presence of the dedicated entertainment device on the network.

42: The article of claim 37, wherein the instructions stipulate that accessing the requested content includes determining at least one of the properties of the requested content selected from the following:
a storage format of the content,
a digital rights management scheme associated with the content,
a sensory format of the content, and
a latency associated with accessing the content.

43: The article of claim 37, wherein the instructions stipulate that pushing at least a first part of the content to the at least one dedicated entertainment device includes:
the entertainment content server initiating communication between the entertainment content server and the at least one dedicated entertainment device;
the entertainment content server transmitting a network identifier to the at least one dedicated entertainment device;
the at least one dedicated entertainment device initiating communication between a content hosting device and the at least one dedicated entertainment device;
utilizing the network identifier, routing at least a first part of the content from the content hosting device to the at least one dedicated entertainment device.

44: The article of claim 37, wherein the instructions stipulate that pushing at least a first part of the content to the at least one dedicated entertainment device includes:
a content hosting device initiating communication between the content hosting device and the at least one dedicated entertainment device;
routing at least a first part of the content from the content hosting device to the at least one dedicated entertainment device.

45: The article of claim 44, wherein the entertainment content server includes the content hosting device.

46: The article of claim 44, wherein the instructions stipulate that pushing at least a first part of the content to the at least one dedicated entertainment device includes:
partitioning the content into a first part and at least a second part,
pushing a first part of the content to a first dedicated entertainment device, and
pushing a second part of the content to a second dedicated entertainment device.

47: The article of claim 46, wherein the instructions stipulate that partitioning the content into a first and second part comprises partitioning the content based upon at least one of the following:
a digital rights management scheme associated with a part of the content,
a latency associated with accessing a part of the content.
a physical location of the dedicated entertainment device to which a part of the content is pushed,
a sensory format of a part of the content,
a storage format of a part of the content,
a substantially predetermined setting, and
a temporal marker.
